(19) United States
(12) Patent Application Publication
(10) Pub. No.: US 2021/0342255 A1
(43) Pub. Date: Nov. 4, 2021

(54) Performance Evaluation Based on Target Metrics

(71) Applicant: ServiceNow, Inc., Santa Clara, CA (US)

(72) Inventors: Denise Ann Oliver, Cupertino, CA (US); Bryanna Lynn Fuller, Campbell, CA (US)

(21) Appl. No.: 16/863,534

(22) Filed: Apr. 30, 2020

(51) Int. Cl. G06F 11/36

(52) U.S. Cl. CPC G06F 11/3672

(57) ABSTRACT

Persistent storage includes measurements relating to components of a managed network. One or more processors may be configured to: obtain, from the persistent storage, an attainment measurement, a years of data measurement, and a tenure measurement all relating to a particular component of the managed network; determine a normalized attainment based on the attainment measurement, a mean attainment over a set of the components, and a standard deviation of attainment over the set of the components; determine a normalized years of data based on the years of data measurement and a maximum years of data available for the set of the components; determine a normalized tenure based on the tenure measurement, the years of data measurement, and a function of the normalized attainment; and determine an output for the particular component based on a combination of the normalized attainment, the normalized years of data, and the normalized tenure.

### BACKGROUND

Performance analysis techniques are helpful in determining the efficacy and worth of a “component.” This component may be a device, a system, a process, and individual or a group. Often, such a performance analysis is based on a target metric given to a component—a certain number of activities to perform, items to produce, or value to create in a given time frame. A simple way of determining the performance of a component is to compare actual outcomes to the component's target metric. When the outcome meets or exceeds the metric, the component may be considered to be performing well, while a component with an outcome that falls short of the metric may be considered to be underperforming.

The result of the performance analysis can be useful in determining whether the component is performing as expected. If not, various remedial actions can be taken, such as adjusting the component, changing the target metric, reassigning the component to a different role, and/or replacing the component with a different component. Nonetheless, such a simplistic target-based evaluation often provides just one data point with respect to the component's performance, and frequently does not take into account nuances and other factors that influence the component's performance and that should influence the expectations thereof.

### SUMMARY

In addition to target metric attainment, other factors that can be helpful in determining component performance include mean target metric attainment across similarly situated components (e.g., components of the same type or in the same group), the amount of data available to use in the performance analysis, how long the component has been in its current role, and the value of the component's contributions. These additional factors are just a few example, and other may exist.

Each of these factors can be weighted and/or combined in various ways to produce an overall score for a component's performance over a pre-defined period of time. As will be established below, this score is (in many cases) superior to just target metric attainment when evaluating the performance of the component. In particular, it allows components with similar attainments to be compared more objectively. As such, the scoring methodology herein can be used in various contexts, such as engineering and scientific activities, computer networking equipment lifecycle management, and employee evaluations.

Accordingly, a first example embodiment may involve persistent storage within a computational instance of a remote network management platform. The computational instance may be dedicated to a managed network. The persistent storage may include measurements relating to components of the managed network. One or more processors configured to: (i) obtain, from the persistent storage, an attainment measurement, a years of data measurement, and a tenure measurement all relating to a particular component of the managed network; (ii) determine a normalized attainment based on the attainment measurement, a mean attainment over a set of the components, and a standard deviation of attainment over the set of the components, wherein the normalized attainment is modified by a predetermined attainment weight; (iii) determine a normalized years of data based on the years of data measurement and a maximum years of data available for the set of the components, wherein the normalized years of data is modified by a predetermined years of data weight; (iv) determine a normalized tenure based on the tenure measurement, the years of data measurement, and a function of the normalized attainment, wherein the normalized tenure is modified by a predetermined tenure weight; (v) determine an output for the particular component based on a combination of the normalized attainment, the normalized years of data, and the normalized tenure; and (vi) store, in the persistent storage, the output in association with the particular component.

A second example embodiment may involve obtaining, from persistent storage, an attainment measurement, a years of data measurement, and a tenure measurement all relating to a particular component of a managed network. The second example embodiment may also involve determining a normalized attainment based on the attainment measurement, a mean attainment over a set of components associated with the managed network, and a standard deviation of attainment over the set of components, wherein the normalized attainment is modified by a predetermined attainment weight. The second example embodiment may also involve determining a normalized years of data based on the years of data measurement and a maximum years of data available for the set of components, wherein the normalized years of data is modified by a predetermined years of data weight. The second example embodiment may also involve determining a normalized tenure based on the tenure measurement, the years of data measurement, and a function of the normalized attainment, wherein the normalized tenure is modified by a predetermined tenure weight. The second example embodiment may also involve determining an output for the particular component based on a combination of the normalized attainment, the normalized years of data, and the normalized tenure. The second example embodiment may also involve storing, in the persistent storage, the output in association with the particular component.

In a third example embodiment, an article of manufacture may include a non-transitory computer-readable medium, having stored thereon program instructions that, upon execution by a computing system, cause the computing system to perform operations in accordance with the first and/or second example embodiment.

In a fourth example embodiment, a computing system may include at least one processor, as well as memory and program instructions. The program instructions may be stored in the memory, and upon execution by the at least one processor, cause the computing system to perform operations in accordance with the first and/or second example embodiment.

In a fifth example embodiment, a system may include various means for carrying out each of the operations of the first and/or second example embodiment.

These, as well as other embodiments, aspects, advantages, and alternatives, will become apparent to those of ordinary skill in the art by reading the following detailed description, with reference where appropriate to the accompanying drawings. Further, this summary and other descriptions and figures provided herein are intended to illustrate embodiments by way of example only and, as such, that numerous variations are possible. For instance, structural elements and process steps can be rearranged, combined, distributed, eliminated, or otherwise changed, while remaining within the scope of the embodiments as claimed.

### BRIEF DESCRIPTION OF THE DRAWINGS

FIG. 1 illustrates a schematic drawing of a computing device, in accordance with example embodiments.

FIG. 2 illustrates a schematic drawing of a server device cluster, in accordance with example embodiments.

FIG. 3 depicts a remote network management architecture, in accordance with example embodiments.

FIG. 4 depicts a communication environment involving a remote network management architecture, in accordance with example embodiments.

FIG. 5A depicts another communication environment involving a remote network management architecture, in accordance with example embodiments.

FIG. 5B is a flow chart, in accordance with example embodiments.

FIG. 6 is a depiction of calculations, in accordance with example embodiments.

FIG. 7 is a table mapping bands of input values to a range of output values, in accordance with example embodiments.

FIG. 8 is a further depiction of calculations, in accordance with example embodiments.

FIG. 9 depicts a table of example performance evaluations, in accordance with example embodiments.

FIG. 10 is a flow chart, in accordance with example embodiments.

### DETAILED DESCRIPTION

Example methods, devices, and systems are described herein. It should be understood that the words “example” and “exemplary” are used herein to mean “serving as an example, instance, or illustration.” Any embodiment or feature described herein as being an “example” or “exemplary” is not necessarily to be construed as preferred or advantageous over other embodiments or features unless stated as such. Thus, other embodiments can be utilized and other changes can be made without departing from the scope of the subject matter presented herein.

Accordingly, the example embodiments described herein are not meant to be limiting. It will be readily understood that the aspects of the present disclosure, as generally described herein, and illustrated in the figures, can be arranged, substituted, combined, separated, and designed in a wide variety of different configurations. For example, the separation of features into “client” and “server” components may occur in a number of ways.

Further, unless context suggests otherwise, the features illustrated in each of the figures may be used in combination with one another. Thus, the figures should be generally viewed as component aspects of one or more overall embodiments, with the understanding that not all illustrated features are necessary for each embodiment.

Additionally, any enumeration of elements, blocks, or steps in this specification or the claims is for purposes of clarity. Thus, such enumeration should not be interpreted to require or imply that these elements, blocks, or steps adhere to a particular arrangement or are carried out in a particular order.

### I. Introduction

A large enterprise is a complex entity with many interrelated operations. Some of these are found across the enterprise, such as human resources (HR), supply chain, information technology (IT), and finance. However, each enterprise also has its own unique operations that provide essential capabilities and/or create competitive advantages.

To support widely-implemented operations, enterprises typically use off-the-shelf software applications, such as customer relationship management (CRM) and human capital management (HCM) packages. However, they may also need custom software applications to meet their own unique requirements. A large enterprise often has dozens or hundreds of these custom software applications. Nonetheless, the advantages provided by the embodiments herein are not limited to large enterprises and may be applicable to an enterprise, or any other type of organization, of any size.

Many such software applications are developed by individual departments within the enterprise. These range from simple spreadsheets to custom-built software tools and databases. But the proliferation of siloed custom software applications has numerous disadvantages. It negatively impacts an enterprise's ability to run and grow its operations, innovate, and meet regulatory requirements. The enterprise may find it difficult to integrate, streamline, and enhance its operations due to lack of a single system that unifies its subsystems and data.

To efficiently create custom applications, enterprises would benefit from a remotely-hosted application platform that eliminates unnecessary development complexity. The goal of such a platform would be to reduce time-consuming, repetitive application development tasks so that software engineers and individuals in other roles can focus on developing unique, high-value features.

In order to achieve this goal, the concept of Application Platform as a Service (aPaaS) is introduced, to intelligently automate workflows throughout the enterprise. An aPaaS system is hosted remotely from the enterprise, but may access data, applications, and services within the enterprise by way of secure connections. Such an aPaaS system may have a number of advantageous capabilities and characteristics. These advantages and characteristics may be able to improve the enterprise's operations and workflows for IT, HR, CRM, customer service, application development, and security.

The aPaaS system may support development and execution of model-view-controller (MVC) applications. MVC applications divide their functionality into three interconnected parts (model, view, and controller) in order to isolate representations of information from the manner in which the information is presented to the user, thereby allowing for efficient code reuse and parallel development. These applications may be web-based, and offer create, read, update, delete (CRUD) capabilities. This allows new applications to be built on a common application infrastructure.

The aPaaS system may support standardized application components, such as a standardized set of widgets for graphical user interface (GUI) development. In this way, applications built using the aPaaS system have a common look and feel. Other software components and modules may be standardized as well. In some cases, this look and feel can be branded or skinned with an enterprise's custom logos and/or color schemes.

The aPaaS system may support the ability to configure the behavior of applications using metadata. This allows application behaviors to be rapidly adapted to meet specific needs. Such an approach reduces development time and increases flexibility. Further, the aPaaS system may support GUI tools that facilitate metadata creation and management, thus reducing errors in the metadata.

The aPaaS system may support clearly-defined interfaces between applications, so that software developers can avoid unwanted inter-application dependencies. Thus, the aPaaS system may implement a service layer in which persistent state information and other data are stored.

The aPaaS system may support a rich set of integration features so that the applications thereon can interact with legacy applications and third-party applications. For instance, the aPaaS system may support a custom employee-onboarding system that integrates with legacy HR, IT, and accounting systems.

The aPaaS system may support enterprise-grade security. Furthermore, since the aPaaS system may be remotely hosted, it should also utilize security procedures when it interacts with systems in the enterprise or third-party networks and services hosted outside of the enterprise. For example, the aPaaS system may be configured to share data amongst the enterprise and other parties to detect and identify common security threats.

Other features, functionality, and advantages of an aPaaS system may exist. This description is for purpose of example and is not intended to be limiting.

As an example of the aPaaS development process, a software developer may be tasked to create a new application using the aPaaS system. First, the developer may define the data model, which specifies the types of data that the application uses and the relationships therebetween. Then, via a GUI of the aPaaS system, the developer enters (e.g., uploads) the data model. The aPaaS system automatically creates all of the corresponding database tables, fields, and relationships, which can then be accessed via an object-oriented services layer.

In addition, the aPaaS system can also build a fully-functional MVC application with client-side interfaces and server-side CRUD logic. This generated application may serve as the basis of further development for the user. Advantageously, the developer does not have to spend a large amount of time on basic application functionality. Further, since the application may be web-based, it can be accessed from any Internet-enabled client device. Alternatively or additionally, a local copy of the application may be able to be accessed, for instance, when Internet service is not available.

The aPaaS system may also support a rich set of pre-defined functionality that can be added to applications. These features include support for searching, email, templating, workflow design, reporting, analytics, social media, scripting, mobile-friendly output, and customized GUIs.

Such an aPaaS system may represent a GUI in various ways. For example, a server device of the aPaaS system may generate a representation of a GUI using a combination of HTML and JAVASCRIPT®. The JAVASCRIPT® may include client-side executable code, server-side executable code, or both. The server device may transmit or otherwise provide this representation to a client device for the client device to display on a screen according to its locally-defined look and feel. Alternatively, a representation of a GUI may take other forms, such as an intermediate form (e.g., JAVA® byte-code) that a client device can use to directly generate graphical output therefrom. Other possibilities exist.

Further, user interaction with GUI elements, such as buttons, menus, tabs, sliders, checkboxes, toggles, etc. may be referred to as “selection”, “activation”, or “actuation” thereof. These terms may be used regardless of whether the GUI elements are interacted with by way of keyboard, pointing device, touchscreen, or another mechanism.

An aPaaS architecture is particularly powerful when integrated with an enterprise's network and used to manage such a network. The following embodiments describe architectural and functional aspects of example aPaaS systems, as well as the features and advantages thereof.

### II. Example Computing Devices and Cloud-Based Computing Environments

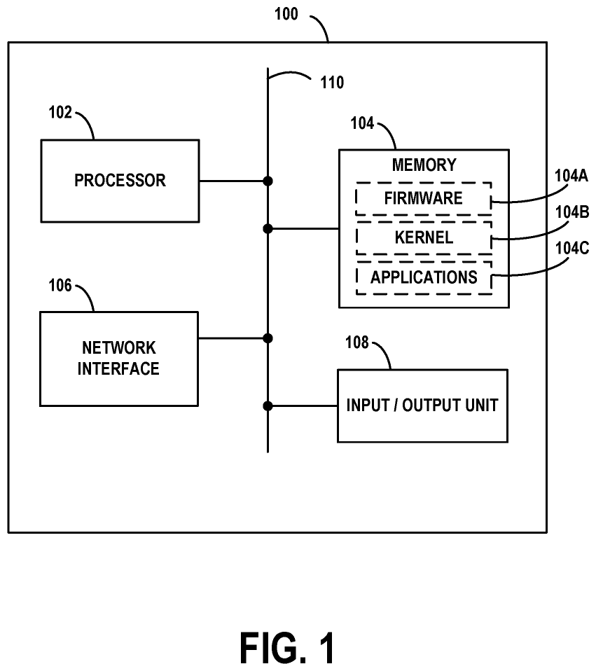

FIG. 1 is a simplified block diagram exemplifying a computing device 100, illustrating some of the components that could be included in a computing device arranged to operate in accordance with the embodiments herein. Computing device 100 could be a client device (e.g., a device actively operated by a user), a server device (e.g., a device that provides computational services to client devices), or some other type of computational platform. Some server devices may operate as client devices from time to time in order to perform particular operations, and some client devices may incorporate server features.

In this example, computing device 100 includes processor 102, memory 104, network interface 106, and input/output unit 108, all of which may be coupled by system bus 110 or a similar mechanism. In some embodiments, computing device 100 may include other components and/or peripheral devices (e.g., detachable storage, printers, and so on).

Processor 102 may be one or more of any type of computer processing element, such as a central processing unit (CPU), a co-processor (e.g., a mathematics, graphics, or encryption co-processor), a digital signal processor (DSP), a network processor, and/or a form of integrated circuit or controller that performs processor operations. In some cases, processor 102 may be one or more single-core processors. In other cases, processor 102 may be one or more multi-core processors with multiple independent processing units. Processor 102 may also include register memory for temporarily storing instructions being executed and related data, as well as cache memory for temporarily storing recently-used instructions and data.

Memory 104 may be any form of computer-usable memory, including but not limited to random access memory (RAM), read-only memory (ROM), and non-volatile memory (e.g., flash memory, hard disk drives, solid state drives, compact discs (CDs), digital video discs (DVDs), and/or tape storage). Thus, memory 104 represents both main memory units, as well as long-term storage. Other types of memory may include biological memory.

Memory 104 may store program instructions and/or data on which program instructions may operate. By way of example, memory 104 may store these program instructions on a non-transitory, computer-readable medium, such that the instructions are executable by processor 102 to carry out any of the methods, processes, or operations disclosed in this specification or the accompanying drawings.

As shown in FIG. 1, memory 104 may include firmware 104A, kernel 104B, and/or applications 104C. Firmware 104A may be program code used to boot or otherwise initiate some or all of computing device 100. Kernel 104B may be an operating system, including modules for memory management, scheduling and management of processes, input/output, and communication. Kernel 104B may also include device drivers that allow the operating system to communicate with the hardware modules (e.g., memory units, networking interfaces, ports, and buses) of computing device 100. Applications 104C may be one or more user-space software programs, such as web browsers or email clients, as well as any software libraries used by these programs. Memory 104 may also store data used by these and other programs and applications.

Network interface 106 may take the form of one or more wireline interfaces, such as Ethernet (e.g., Fast Ethernet, Gigabit Ethernet, and so on). Network interface 106 may also support communication over one or more non-Ethernet media, such as coaxial cables or power lines, or over wide-area media, such as Synchronous Optical Networking (SONET) or digital subscriber line (DSL) technologies. Network interface 106 may additionally take the form of one or more wireless interfaces, such as IEEE 802.11 (Wifi), BLUETOOTH®, global positioning system (GPS), or a wide-area wireless interface. However, other forms of physical layer interfaces and other types of standard or proprietary communication protocols may be used over network interface 106. Furthermore, network interface 106 may comprise multiple physical interfaces. For instance, some embodiments of computing device 100 may include Ethernet, BLUETOOTH®, and Wifi interfaces.

Input/output unit 108 may facilitate user and peripheral device interaction with computing device 100. Input/output unit 108 may include one or more types of input devices, such as a keyboard, a mouse, a touch screen, and so on. Similarly, input/output unit 108 may include one or more types of output devices, such as a screen, monitor, printer, and/or one or more light emitting diodes (LEDs). Additionally or alternatively, computing device 100 may communicate with other devices using a universal serial bus (USB) or high-definition multimedia interface (HDMI) port interface, for example.

In some embodiments, one or more computing devices like computing device 100 may be deployed to support an aPaaS architecture. The exact physical location, connectivity, and configuration of these computing devices may be unknown and/or unimportant to client devices. Accordingly, the computing devices may be referred to as “cloud-based” devices that may be housed at various remote data center locations.

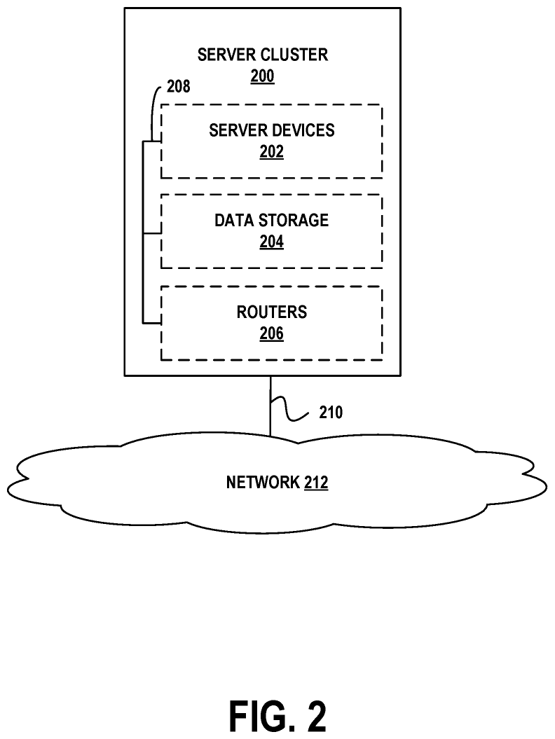

FIG. 2 depicts a cloud-based server cluster 200 in accordance with example embodiments. In FIG. 2, operations of a computing device (e.g., computing device 100) may be distributed between server devices 202, data storage 204, and routers 206, all of which may be connected by local cluster network 208. The number of server devices 202, data storages 204, and routers 206 in server cluster 200 may depend on the computing task(s) and/or applications assigned to server cluster 200.

For example, server devices 202 can be configured to perform various computing tasks of computing device 100. Thus, computing tasks can be distributed among one or more of server devices 202. To the extent that these computing tasks can be performed in parallel, such a distribution of tasks may reduce the total time to complete these tasks and return a result. For purposes of simplicity, both server cluster 200 and individual server devices 202 may be referred to as a “server device.” This nomenclature should be understood to imply that one or more distinct server devices, data storage devices, and cluster routers may be involved in server device operations.

Data storage 204 may be data storage arrays that include drive array controllers configured to manage read and write access to groups of hard disk drives and/or solid state drives. The drive array controllers, alone or in conjunction with server devices 202, may also be configured to manage backup or redundant copies of the data stored in data storage 204 to protect against drive failures or other types of failures that prevent one or more of server devices 202 from accessing units of data storage 204. Other types of memory aside from drives may be used.

Routers 206 may include networking equipment configured to provide internal and external communications for server cluster 200. For example, routers 206 may include one or more packet-switching and/or routing devices (including switches and/or gateways) configured to provide (i) network communications between server devices 202 and data storage 204 via local cluster network 208, and/or (ii) network communications between server cluster 200 and other devices via communication link 210 to network 212.

Additionally, the configuration of routers 206 can be based at least in part on the data communication requirements of server devices 202 and data storage 204, the latency and throughput of the local cluster network 208, the latency, throughput, and cost of communication link 210, and/or other factors that may contribute to the cost, speed, fault-tolerance, resiliency, efficiency, and/or other design goals of the system architecture.

As a possible example, data storage 204 may include any form of database, such as a structured query language (SQL) database. Various types of data structures may store the information in such a database, including but not limited to tables, arrays, lists, trees, and tuples. Furthermore, any databases in data storage 204 may be monolithic or distributed across multiple physical devices.

Server devices 202 may be configured to transmit data to and receive data from data storage 204. This transmission and retrieval may take the form of SQL queries or other types of database queries, and the output of such queries, respectively. Additional text, images, video, and/or audio may be included as well. Furthermore, server devices 202 may organize the received data into web page or web application representations. Such a representation may take the form of a markup language, such as the hypertext markup language (HTML), the extensible markup language (XML), or some other standardized or proprietary format. Moreover, server devices 202 may have the capability of executing various types of computerized scripting languages, such as but not limited to Perl, Python, PHP Hypertext Preprocessor (PHP), Active Server Pages (ASP), JAVASCRIPT®, and so on. Computer program code written in these languages may facilitate the providing of web pages to client devices, as well as client device interaction with the web pages. Alternatively or additionally, JAVA® may be used to facilitate generation of web pages and/or to provide web application functionality.

### III. Example Remote Network Management Architecture

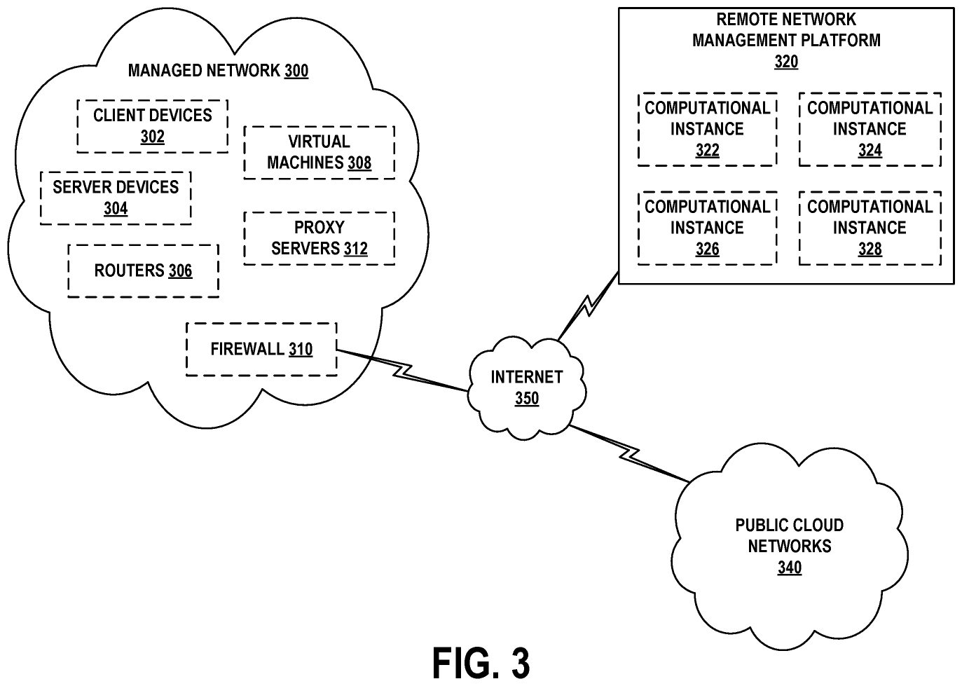

FIG. 3 depicts a remote network management architecture, in accordance with example embodiments. This architecture includes three main components—managed network 300, remote network management platform 320, and public cloud networks 340—all connected by way of Internet 350.

A. Managed Networks

Managed network 300 may be, for example, an enterprise network used by an entity for computing and communications tasks, as well as storage of data. Thus, managed network 300 may include client devices 302, server devices 304, routers 306, virtual machines 308, firewall 310, and/or proxy servers 312. Client devices 302 may be embodied by computing device 100, server devices 304 may be embodied by computing device 100 or server cluster 200, and routers 306 may be any type of router, switch, or gateway.

Virtual machines 308 may be embodied by one or more of computing device 100 or server cluster 200. In general, a virtual machine is an emulation of a computing system, and mimics the functionality (e.g., processor, memory, and communication resources) of a physical computer. One physical computing system, such as server cluster 200, may support up to thousands of individual virtual machines. In some embodiments, virtual machines 308 may be managed by a centralized server device or application that facilitates allocation of physical computing resources to individual virtual machines, as well as performance and error reporting. Enterprises often employ virtual machines in order to allocate computing resources in an efficient, as needed fashion. Providers of virtualized computing systems include VMWARE® and MICROSOFT®.

Firewall 310 may be one or more specialized routers or server devices that protect managed network 300 from unauthorized attempts to access the devices, applications, and services therein, while allowing authorized communication that is initiated from managed network 300. Firewall 310 may also provide intrusion detection, web filtering, virus scanning, application-layer gateways, and other applications or services. In some embodiments not shown in FIG. 3, managed network 300 may include one or more virtual private network (VPN) gateways with which it communicates with remote network management platform 320 (see below).

Managed network 300 may also include one or more proxy servers 312. An embodiment of proxy servers 312 may be a server application that facilitates communication and movement of data between managed network 300, remote network management platform 320, and public cloud networks 340. In particular, proxy servers 312 may be able to establish and maintain secure communication sessions with one or more computational instances of remote network management platform 320. By way of such a session, remote network management platform 320 may be able to discover and manage aspects of the architecture and configuration of managed network 300 and its components. Possibly with the assistance of proxy servers 312, remote network management platform 320 may also be able to discover and manage aspects of public cloud networks 340 that are used by managed network 300.

Firewalls, such as firewall 310, typically deny all communication sessions that are incoming by way of Internet 350, unless such a session was ultimately initiated from behind the firewall (i.e., from a device on managed network 300) or the firewall has been explicitly configured to support the session. By placing proxy servers 312 behind firewall 310 (e.g., within managed network 300 and protected by firewall 310), proxy servers 312 may be able to initiate these communication sessions through firewall 310. Thus, firewall 310 might not have to be specifically configured to support incoming sessions from remote network management platform 320, thereby avoiding potential security risks to managed network 300.

In some cases, managed network 300 may consist of a few devices and a small number of networks. In other deployments, managed network 300 may span multiple physical locations and include hundreds of networks and hundreds of thousands of devices. Thus, the architecture depicted in FIG. 3 is capable of scaling up or down by orders of magnitude.

Furthermore, depending on the size, architecture, and connectivity of managed network 300, a varying number of proxy servers 312 may be deployed therein. For example, each one of proxy servers 312 may be responsible for communicating with remote network management platform 320 regarding a portion of managed network 300. Alternatively or additionally, sets of two or more proxy servers may be assigned to such a portion of managed network 300 for purposes of load balancing, redundancy, and/or high availability.

B. Remote Network Management Platforms

Remote network management platform 320 is a hosted environment that provides aPaaS services to users, particularly to the operator of managed network 300. These services may take the form of web-based portals, for example, using the aforementioned web-based technologies. Thus, a user can securely access remote network management platform 320 from, for example, client devices 302, or potentially from a client device outside of managed network 300. By way of the web-based portals, users may design, test, and deploy applications, generate reports, view analytics, and perform other tasks.

As shown in FIG. 3, remote network management platform 320 includes four computational instances 322, 324, 326, and 328. Each of these computational instances may represent one or more server nodes operating dedicated copies of the aPaaS software and/or one or more database nodes. The arrangement of server and database nodes on physical server devices and/or virtual machines can be flexible and may vary based on enterprise needs. In combination, these nodes may provide a set of web portals, services, and applications (e.g., a wholly-functioning aPaaS system) available to a particular enterprise. In some cases, a single enterprise may use multiple computational instances.

For example, managed network 300 may be an enterprise customer of remote network management platform 320, and may use computational instances 322, 324, and 326. The reason for providing multiple computational instances to one customer is that the customer may wish to independently develop, test, and deploy its applications and services. Thus, computational instance 322 may be dedicated to application development related to managed network 300, computational instance 324 may be dedicated to testing these applications, and computational instance 326 may be dedicated to the live operation of tested applications and services. A computational instance may also be referred to as a hosted instance, a remote instance, a customer instance, or by some other designation. Any application deployed onto a computational instance may be a scoped application, in that its access to databases within the computational instance can be restricted to certain elements therein (e.g., one or more particular database tables or particular rows within one or more database tables).

For purposes of clarity, the disclosure herein refers to the arrangement of application nodes, database nodes, aPaaS software executing thereon, and underlying hardware as a “computational instance.” Note that users may colloquially refer to the graphical user interfaces provided thereby as “instances.” But unless it is defined otherwise herein, a “computational instance” is a computing system disposed within remote network management platform 320.

The multi-instance architecture of remote network management platform 320 is in contrast to conventional multi-tenant architectures, over which multi-instance architectures exhibit several advantages. In multi-tenant architectures, data from different customers (e.g., enterprises) are comingled in a single database. While these customers' data are separate from one another, the separation is enforced by the software that operates the single database. As a consequence, a security breach in this system may impact all customers' data, creating additional risk, especially for entities subject to governmental, healthcare, and/or financial regulation. Furthermore, any database operations that impact one customer will likely impact all customers sharing that database. Thus, if there is an outage due to hardware or software errors, this outage affects all such customers. Likewise, if the database is to be upgraded to meet the needs of one customer, it will be unavailable to all customers during the upgrade process. Often, such maintenance windows will be long, due to the size of the shared database.

In contrast, the multi-instance architecture provides each customer with its own database in a dedicated computing instance. This prevents comingling of customer data, and allows each instance to be independently managed. For example, when one customer's instance experiences an outage due to errors or an upgrade, other computational instances are not impacted. Maintenance down time is limited because the database only contains one customer's data. Further, the simpler design of the multi-instance architecture allows redundant copies of each customer database and instance to be deployed in a geographically diverse fashion. This facilitates high availability, where the live version of the customer's instance can be moved when faults are detected or maintenance is being performed.

In some embodiments, remote network management platform 320 may include one or more central instances, controlled by the entity that operates this platform. Like a computational instance, a central instance may include some number of application and database nodes disposed upon some number of physical server devices or virtual machines. Such a central instance may serve as a repository for specific configurations of computational instances as well as data that can be shared amongst at least some of the computational instances. For instance, definitions of common security threats that could occur on the computational instances, software packages that are commonly discovered on the computational instances, and/or an application store for applications that can be deployed to the computational instances may reside in a central instance. Computational instances may communicate with central instances by way of well-defined interfaces in order to obtain this data.

In order to support multiple computational instances in an efficient fashion, remote network management platform 320 may implement a plurality of these instances on a single hardware platform. For example, when the aPaaS system is implemented on a server cluster such as server cluster 200, it may operate virtual machines that dedicate varying amounts of computational, storage, and communication resources to instances. But full virtualization of server cluster 200 might not be necessary, and other mechanisms may be used to separate instances. In some examples, each instance may have a dedicated account and one or more dedicated databases on server cluster 200. Alternatively, a computational instance such as computational instance 322 may span multiple physical devices.

In some cases, a single server cluster of remote network management platform 320 may support multiple independent enterprises. Furthermore, as described below, remote network management platform 320 may include multiple server clusters deployed in geographically diverse data centers in order to facilitate load balancing, redundancy, and/or high availability.

C. Public Cloud Networks

Public cloud networks 340 may be remote server devices (e.g., a plurality of server clusters such as server cluster 200) that can be used for outsourced computation, data storage, communication, and service hosting operations. These servers may be virtualized (i.e., the servers may be virtual machines). Examples of public cloud networks 340 may include AMAZON WEB SERVICES® and MICROSOFT® AZURE®. Like remote network management platform 320, multiple server clusters supporting public cloud networks 340 may be deployed at geographically diverse locations for purposes of load balancing, redundancy, and/or high availability.

Managed network 300 may use one or more of public cloud networks 340 to deploy applications and services to its clients and customers. For instance, if managed network 300 provides online music streaming services, public cloud networks 340 may store the music files and provide web interface and streaming capabilities. In this way, the enterprise of managed network 300 does not have to build and maintain its own servers for these operations.

Remote network management platform 320 may include modules that integrate with public cloud networks 340 to expose virtual machines and managed services therein to managed network 300. The modules may allow users to request virtual resources, discover allocated resources, and provide flexible reporting for public cloud networks 340. In order to establish this functionality, a user from managed network 300 might first establish an account with public cloud networks 340, and request a set of associated resources. Then, the user may enter the account information into the appropriate modules of remote network management platform 320. These modules may then automatically discover the manageable resources in the account, and also provide reports related to usage, performance, and billing.

D. Communication Support and Other Operations

Internet 350 may represent a portion of the global Internet. However, Internet 350 may alternatively represent a different type of network, such as a private wide-area or local-area packet-switched network.

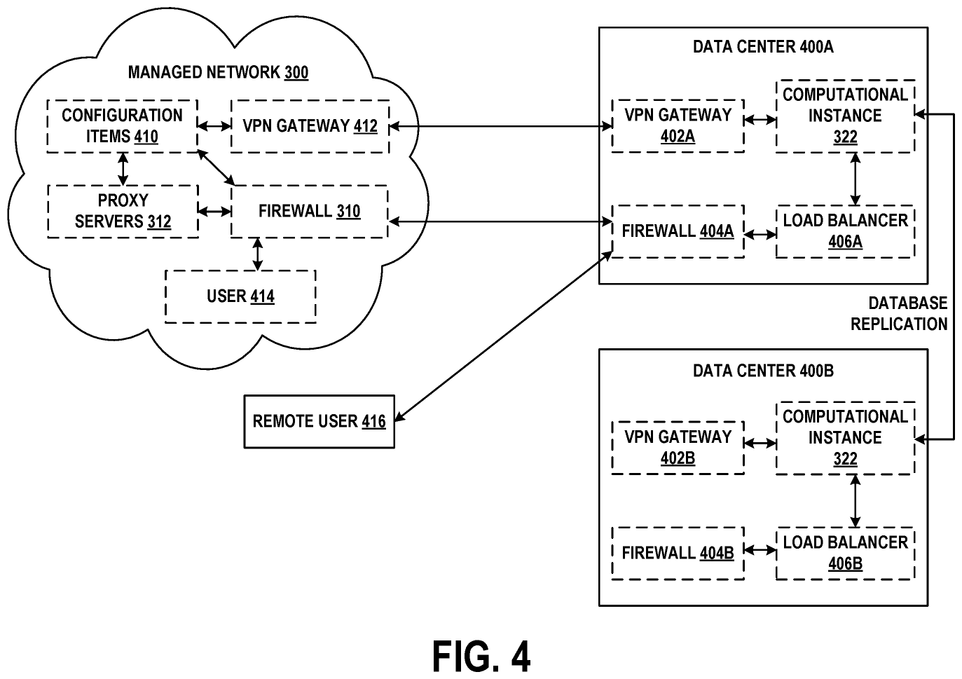

FIG. 4 further illustrates the communication environment between managed network 300 and computational instance 322, and introduces additional features and alternative embodiments. In FIG. 4, computational instance 322 is replicated across data centers 400A and 400B. These data centers may be geographically distant from one another, perhaps in different cities or different countries. Each data center includes support equipment that facilitates communication with managed network 300, as well as remote users.

In data center 400A, network traffic to and from external devices flows either through VPN gateway 402A or firewall 404A. VPN gateway 402A may be peered with VPN gateway 412 of managed network 300 by way of a security protocol such as Internet Protocol Security (IPSEC) or Transport Layer Security (TLS). Firewall 404A may be configured to allow access from authorized users, such as user 414 and remote user 416, and to deny access to unauthorized users. By way of firewall 404A, these users may access computational instance 322, and possibly other computational instances. Load balancer 406A may be used to distribute traffic amongst one or more physical or virtual server devices that host computational instance 322. Load balancer 406A may simplify user access by hiding the internal configuration of data center 400A, (e.g., computational instance 322) from client devices. For instance, if computational instance 322 includes multiple physical or virtual computing devices that share access to multiple databases, load balancer 406A may distribute network traffic and processing tasks across these computing devices and databases so that no one computing device or database is significantly busier than the others. In some embodiments, computational instance 322 may include VPN gateway 402A, firewall 404A, and load balancer 406A.

Data center 400B may include its own versions of the components in data center 400A. Thus, VPN gateway 402B, firewall 404B, and load balancer 406B may perform the same or similar operations as VPN gateway 402A, firewall 404A, and load balancer 406A, respectively. Further, by way of real-time or near-real-time database replication and/or other operations, computational instance 322 may exist simultaneously in data centers 400A and 400B.

Data centers 400A and 400B as shown in FIG. 4 may facilitate redundancy and high availability. In the configuration of FIG. 4, data center 400A is active and data center 400B is passive. Thus, data center 400A is serving all traffic to and from managed network 300, while the version of computational instance 322 in data center 400B is being updated in near-real-time. Other configurations, such as one in which both data centers are active, may be supported.

Should data center 400A fail in some fashion or otherwise become unavailable to users, data center 400B can take over as the active data center. For example, domain name system (DNS) servers that associate a domain name of computational instance 322 with one or more Internet Protocol (IP) addresses of data center 400A may re-associate the domain name with one or more IP addresses of data center 400B. After this re-association completes (which may take less than one second or several seconds), users may access computational instance 322 by way of data center 400B.

FIG. 4 also illustrates a possible configuration of managed network 300. As noted above, proxy servers 312 and user 414 may access computational instance 322 through firewall 310. Proxy servers 312 may also access configuration items 410. In FIG. 4, configuration items 410 may refer to any or all of client devices 302, server devices 304, routers 306, and virtual machines 308, any applications or services executing thereon, as well as relationships between devices, applications, and services. Thus, the term “configuration items” may be shorthand for any physical or virtual device, or any application or service remotely discoverable or managed by computational instance 322, or relationships between discovered devices, applications, and services. Configuration items may be represented in a configuration management database (CMDB) of computational instance 322.

As noted above, VPN gateway 412 may provide a dedicated VPN to VPN gateway 402A. Such a VPN may be helpful when there is a significant amount of traffic between managed network 300 and computational instance 322, or security policies otherwise suggest or require use of a VPN between these sites. In some embodiments, any device in managed network 300 and/or computational instance 322 that directly communicates via the VPN is assigned a public IP address. Other devices in managed network 300 and/or computational instance 322 may be assigned private IP addresses (e.g., IP addresses selected from the 10.0.0.0-10.255.255.255 or 192.168.0.0-192.168.255.255 ranges, represented in shorthand as subnets 10.0.0.0/8 and 192.168.0.0/16, respectively).

### IV. Example Device, Application, and Service Discovery

In order for remote network management platform 320 to administer the devices, applications, and services of managed network 300, remote network management platform 320 may first determine what devices are present in managed network 300, the configurations and operational statuses of these devices, and the applications and services provided by the devices, as well as the relationships between discovered devices, applications, and services. As noted above, each device, application, service, and relationship may be referred to as a configuration item. The process of defining configuration items within managed network 300 is referred to as discovery, and may be facilitated at least in part by proxy servers 312.

For purposes of the embodiments herein, an “application” may refer to one or more processes, threads, programs, client modules, server modules, or any other software that executes on a device or group of devices. A “service” may refer to a high-level capability provided by multiple applications executing on one or more devices working in conjunction with one another. For example, a high-level web service may involve multiple web application server threads executing on one device and accessing information from a database application that executes on another device.

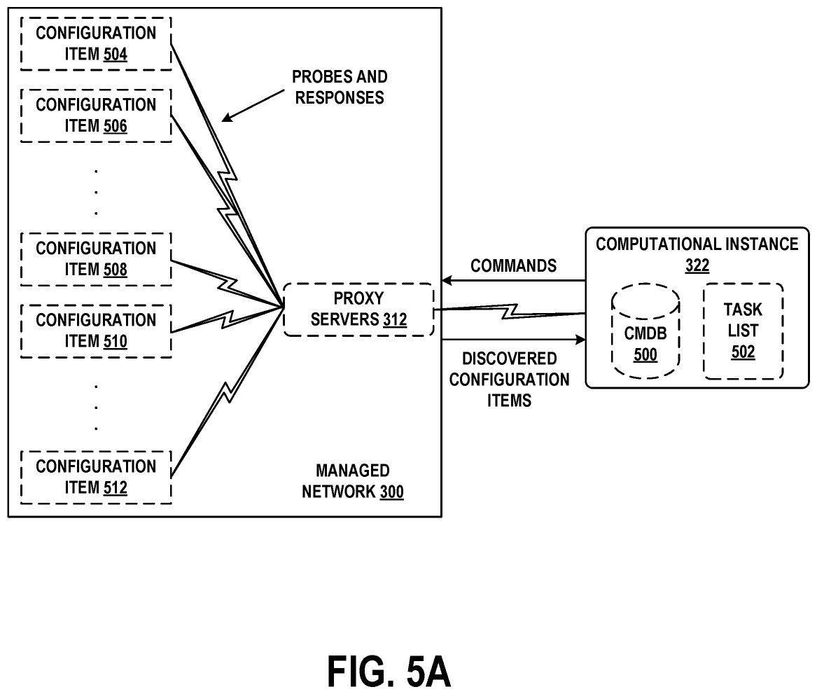

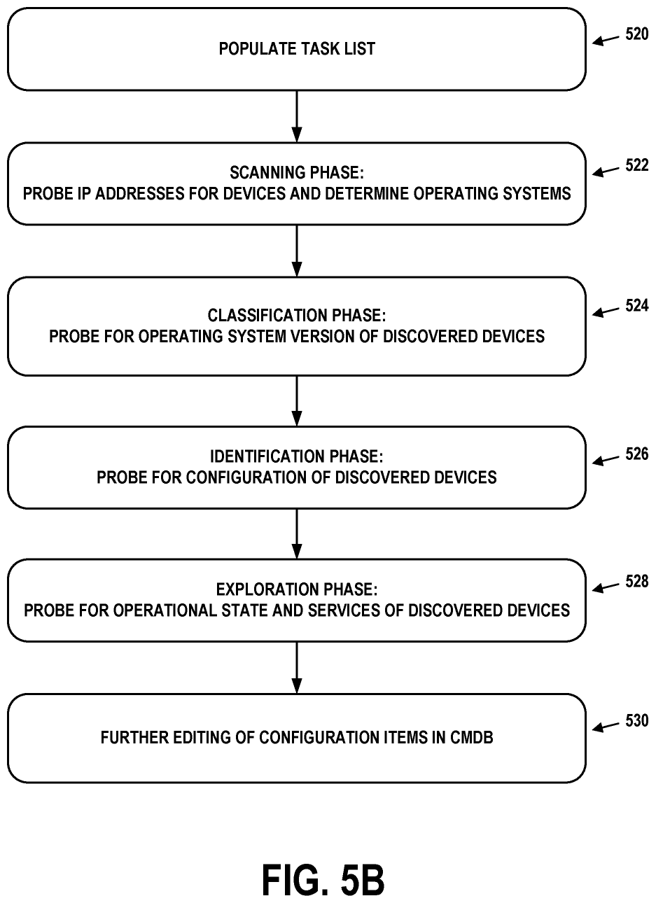

FIG. 5A provides a logical depiction of how configuration items can be discovered, as well as how information related to discovered configuration items can be stored. For sake of simplicity, remote network management platform 320, public cloud networks 340, and Internet 350 are not shown.

In FIG. 5A, CMDB 500 and task list 502 are stored within computational instance 322. Computational instance 322 may transmit discovery commands to proxy servers 312. In response, proxy servers 312 may transmit probes to various devices, applications, and services in managed network 300. These devices, applications, and services may transmit responses to proxy servers 312, and proxy servers 312 may then provide information regarding discovered configuration items to CMDB 500 for storage therein. Configuration items stored in CMDB 500 represent the environment of managed network 300.

Task list 502 represents a list of activities that proxy servers 312 are to perform on behalf of computational instance 322. As discovery takes place, task list 502 is populated. Proxy servers 312 repeatedly query task list 502, obtain the next task therein, and perform this task until task list 502 is empty or another stopping condition has been reached.

To facilitate discovery, proxy servers 312 may be configured with information regarding one or more subnets in managed network 300 that are reachable by way of proxy servers 312. For instance, proxy servers 312 may be given the IP address range 192.168.0/24 as a subnet. Then, computational instance 322 may store this information in CMDB 500 and place tasks in task list 502 for discovery of devices at each of these addresses.

FIG. 5A also depicts devices, applications, and services in managed network 300 as configuration items 504, 506, 508, 510, and 512. As noted above, these configuration items represent a set of physical and/or virtual devices (e.g., client devices, server devices, routers, or virtual machines), applications executing thereon (e.g., web servers, email servers, databases, or storage arrays), relationships therebetween, as well as services that involve multiple individual configuration items.

Placing the tasks in task list 502 may trigger or otherwise cause proxy servers 312 to begin discovery. Alternatively or additionally, discovery may be manually triggered or automatically triggered based on triggering events (e.g., discovery may automatically begin once per day at a particular time).

In general, discovery may proceed in four logical phases: scanning, classification, identification, and exploration. Each phase of discovery involves various types of probe messages being transmitted by proxy servers 312 to one or more devices in managed network 300. The responses to these probes may be received and processed by proxy servers 312, and representations thereof may be transmitted to CMDB 500. Thus, each phase can result in more configuration items being discovered and stored in CMDB 500.

In the scanning phase, proxy servers 312 may probe each IP address in the specified range of IP addresses for open Transmission Control Protocol (TCP) and/or User Datagram Protocol (UDP) ports to determine the general type of device. The presence of such open ports at an IP address may indicate that a particular application is operating on the device that is assigned the IP address, which in turn may identify the operating system used by the device. For example, if TCP port 135 is open, then the device is likely executing a WINDOWS® operating system. Similarly, if TCP port 22 is open, then the device is likely executing a UNIX® operating system, such as LINUX®. If UDP port 161 is open, then the device may be able to be further identified through the Simple Network Management Protocol (SNMP). Other possibilities exist. Once the presence of a device at a particular IP address and its open ports have been discovered, these configuration items are saved in CMDB 500.

In the classification phase, proxy servers 312 may further probe each discovered device to determine the version of its operating system. The probes used for a particular device are based on information gathered about the devices during the scanning phase. For example, if a device is found with TCP port 22 open, a set of UNIX®-specific probes may be used. Likewise, if a device is found with TCP port 135 open, a set of WINDOWS®-specific probes may be used. For either case, an appropriate set of tasks may be placed in task list 502 for proxy servers 312 to carry out. These tasks may result in proxy servers 312 logging on, or otherwise accessing information from the particular device. For instance, if TCP port 22 is open, proxy servers 312 may be instructed to initiate a Secure Shell (SSH) connection to the particular device and obtain information about the operating system thereon from particular locations in the file system. Based on this information, the operating system may be determined. As an example, a UNIX® device with TCP port 22 open may be classified as AIX®, HPUX, LINUX®, MACOS®, or SOLARIS®. This classification information may be stored as one or more configuration items in CMDB 500.

In the identification phase, proxy servers 312 may determine specific details about a classified device. The probes used during this phase may be based on information gathered about the particular devices during the classification phase. For example, if a device was classified as LINUX®, a set of LINUX®-specific probes may be used. Likewise, if a device was classified as WINDOWS® 2012, as a set of WINDOWS®-2012-specific probes may be used. As was the case for the classification phase, an appropriate set of tasks may be placed in task list 502 for proxy servers 312 to carry out. These tasks may result in proxy servers 312 reading information from the particular device, such as basic input/output system (BIOS) information, serial numbers, network interface information, media access control address(es) assigned to these network interface(s), IP address(es) used by the particular device and so on. This identification information may be stored as one or more configuration items in CMDB 500.

In the exploration phase, proxy servers 312 may determine further details about the operational state of a classified device. The probes used during this phase may be based on information gathered about the particular devices during the classification phase and/or the identification phase. Again, an appropriate set of tasks may be placed in task list 502 for proxy servers 312 to carry out. These tasks may result in proxy servers 312 reading additional information from the particular device, such as processor information, memory information, lists of running processes (applications), and so on. Once more, the discovered information may be stored as one or more configuration items in CMDB 500.

Running discovery on a network device, such as a router, may utilize SNMP. Instead of or in addition to determining a list of running processes or other application-related information, discovery may determine additional subnets known to the router and the operational state of the router's network interfaces (e.g., active, inactive, queue length, number of packets dropped, etc.). The IP addresses of the additional subnets may be candidates for further discovery procedures. Thus, discovery may progress iteratively or recursively.

Once discovery completes, a snapshot representation of each discovered device, application, and service is available in CMDB 500. For example, after discovery, operating system version, hardware configuration, and network configuration details for client devices, server devices, and routers in managed network 300, as well as applications executing thereon, may be stored. This collected information may be presented to a user in various ways to allow the user to view the hardware composition and operational status of devices, as well as the characteristics of services that span multiple devices and applications.

Furthermore, CMDB 500 may include entries regarding dependencies and relationships between configuration items. More specifically, an application that is executing on a particular server device, as well as the services that rely on this application, may be represented as such in CMDB 500. For example, suppose that a database application is executing on a server device, and that this database application is used by a new employee onboarding service as well as a payroll service. Thus, if the server device is taken out of operation for maintenance, it is clear that the employee onboarding service and payroll service will be impacted. Likewise, the dependencies and relationships between configuration items may be able to represent the services impacted when a particular router fails.

In general, dependencies and relationships between configuration items may be displayed on a web-based interface and represented in a hierarchical fashion. Thus, adding, changing, or removing such dependencies and relationships may be accomplished by way of this interface.

Furthermore, users from managed network 300 may develop workflows that allow certain coordinated activities to take place across multiple discovered devices. For instance, an IT workflow might allow the user to change the common administrator password to all discovered LINUX® devices in a single operation.

In order for discovery to take place in the manner described above, proxy servers 312, CMDB 500, and/or one or more credential stores may be configured with credentials for one or more of the devices to be discovered. Credentials may include any type of information needed in order to access the devices. These may include userid/password pairs, certificates, and so on. In some embodiments, these credentials may be stored in encrypted fields of CMDB 500. Proxy servers 312 may contain the decryption key for the credentials so that proxy servers 312 can use these credentials to log on to or otherwise access devices being discovered.

The discovery process is depicted as a flow chart in FIG. 5B. At block 520, the task list in the computational instance is populated, for instance, with a range of IP addresses. At block 522, the scanning phase takes place. Thus, the proxy servers probe the IP addresses for devices using these IP addresses, and attempt to determine the operating systems that are executing on these devices. At block 524, the classification phase takes place. The proxy servers attempt to determine the operating system version of the discovered devices. At block 526, the identification phase takes place. The proxy servers attempt to determine the hardware and/or software configuration of the discovered devices. At block 528, the exploration phase takes place. The proxy servers attempt to determine the operational state and applications executing on the discovered devices. At block 530, further editing of the configuration items representing the discovered devices and applications may take place. This editing may be automated and/or manual in nature.

The blocks represented in FIG. 5B are examples. Discovery may be a highly configurable procedure that can have more or fewer phases, and the operations of each phase may vary. In some cases, one or more phases may be customized, or may otherwise deviate from the exemplary descriptions above.

In this manner, a remote network management platform may discover and inventory the hardware, software, and services deployed on and provided by the managed network. As noted above, this data may be stored in a CMDB of the associated computational instance as configuration items. For example, individual hardware components (e.g., computing devices, virtual servers, databases, routers, etc.) may be represented as hardware configuration items, while the applications installed and/or executing thereon may be represented as software configuration items.

The relationship between a software configuration item installed or executing on a hardware configuration item may take various forms, such as “is hosted on”, “runs on”, or “depends on”. Thus, a database application installed on a server device may have the relationship “is hosted on” with the server device to indicate that the database application is hosted on the server device. In some embodiments, the server device may have a reciprocal relationship of “used by” with the database application to indicate that the server device is used by the database application. These relationships may be automatically found using the discovery procedures described above, though it is possible to manually set relationships as well.

The relationship between a service and one or more software configuration items may also take various forms. As an example, a web service may include a web server software configuration item and a database application software configuration item, each installed on different hardware configuration items. The web service may have a “depends on” relationship with both of these software configuration items, while the software configuration items have a “used by” reciprocal relationship with the web service. Services might not be able to be fully determined by discovery procedures, and instead may rely on service mapping (e.g., probing configuration files and/or carrying out network traffic analysis to determine service level relationships between configuration items) and possibly some extent of manual configuration.

Regardless of how relationship information is obtained, it can be valuable for the operation of a managed network. Notably, IT personnel can quickly determine where certain software applications are deployed, and what configuration items make up a service. This allows for rapid pinpointing of root causes of service outages or degradation. For example, if two different services are suffering from slow response times, the CMDB can be queried (perhaps among other activities) to determine that the root cause is a database application that is used by both services having high processor utilization. Thus, IT personnel can address the database application rather than waste time considering the health and performance of other configuration items that make up the services.

### V. Performance Evaluation Scoring

The enterprise context discussed herein is an example candidate for using improved performance evaluation scoring techniques. For instance, enterprise network components, such as server devices, switches, routers, and so on may have certain expectations throughout their lifecycles regarding target metrics such as uptime, available processor and memory capacity, and/or transaction rates (e.g., messages, packets, or bits per second processed). For instance, a router deployed in a managed network may have an expected uptime (time between reboots) of 60 days, may be expected to keep its available processor and memory capacity above 50% on average, and to be able to sustain 5 gigabits per second in traffic load.

But other aspects of enterprise component performance can also benefit from the embodiments herein. For example, a customer service agent may be evaluated based on target metrics such as mean time per customer engagement, mean customer engagements per day, and/or customer satisfaction scores. Likewise, an enterprise sales representative may be evaluated based on quota attainment.

By incorporating the factors of mean target metric attainment across similarly situated components, the amount of data available to use in the performance analysis, how long the component has been in its current role, and the value of the component's contributions, the performance evaluation of any of these components can be made to be more accurate, realistic, and useful. In particular, the scoring framework disclosed herein can be used across components of the same or a similar type, within a particular group, or regionally. Further, the framework balances the evaluation, so a component is not under-valued for failing to meet its target metric from time to time and the component is not over-valued for meeting its target metric once or twice.

Moreover, these techniques can be used in many ways and for many types of components not explicitly discussed herein. For example, evaluating engineering and scientific components, such as technical equipment and processes (e.g., measurement, data processing, and manufacturing devices and methods) can benefit from the disclosure herein. For sake of simplicity, examples below are given for adapting these techniques for evaluating quota attainment in an enterprise context. Nonetheless, persons of skill in the art would understand that the embodiments can be applied in other fields.

To that point, enterprise sales representatives are individuals that carry out a sales process with customers and potential customers. Regardless of the types of products or services that the enterprise provides (e.g., machinery, IT services, financial analysis, outsourcing), this process may involve initial contact and/or meetings, providing demonstrations, answering information requests, managing the involvement of technical experts, negotiating contracts, and closing purchases. Once a sale has been made, the representative may remain a point of contact for customer questions, issue escalation, and follow-on purchases.

In many industries, the sales cycle can be on the scale of weeks, months, or even years from initial contact to closing. As a consequence, the performance of representatives can be difficult to assess within any fixed time frame, as the length of the cycle can be greater than most time frames within which employee performance is evaluated (e.g., one month, one quarter, one year).

This results in managers evaluating representatives in a subjective fashion, based more on the manager's memory than objective data. Doing so opens the door for biases (conscious or unconscious) or favoritism to creep into these evaluations. For example, the manager might recall one great thing that the representative did several years ago, or one bad thing that the representative did several years ago, and this recollection may dominate that of the day-to-day work that the representative has carried out since then. Such evaluations can be unfair to representatives.

The embodiments herein, as adapted to representatives, provide scores that takes into account quota attainment, quota value, the representatives' tenure with the enterprise, and the amount of data used in determining the scores. The scores produced in this fashion are more objective and accurately reflect the actual performance of the representatives. In particular, it allows successful representatives to be clearly identified, while also identifying representatives that may need more assistance or training in carrying out their duties.

In some cases, these evaluations can be used to reduce short-term thinking in representatives. For example, if a representative believes that he or she is being evaluated and compensated on a quarterly basis, he or she may push to close more sales in the current quarter at a discount rather than let those cycles progress at a natural pace, perhaps with less or no discount.

Furthermore, the embodiments herein incorporate a methodology that puts representatives that service different sectors (e.g., commercial versus government, or regionally-based sectors) on the same scale. In this fashion, representative performance across sectors can be more accurately characterized and compared.

In line with the discussion above, a representative's score may be based on at least four factors: quota attainment, years of data, tenure, and quota value. The score may weight and/or combine each of these factors in various ways to increase or decrease the influence of each on the final score. But, in general, higher values for these factors result in a higher score for a representative.

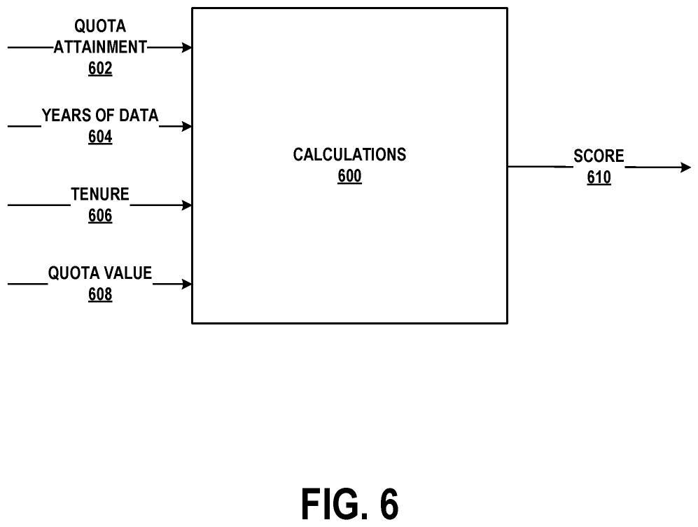

These aspects are illustrated in FIG. 6. Calculations 600 take as input quota attainment 602, years of data 604, tenure 606, and quota value 608. From these, along with one or more additive or multiplicative constants, calculations 600 may produce score 610. Score 610 may be a linear or non-linear combination of the inputs and constants. The examples below describe each of these inputs in detail along with example uses of constants therewith. Nonetheless, other formulas may be used to produce score 610.

A. Quota Attainment

Quota attainment may measure a representative's performance against a predetermined goal. This metric may take the form of a percentage. For example, with a quota of $1,000,000 and actual sales of $900,000, the representative's quota attainment is 90%. Thus, quota attainment below 100% indicates that the representative has not met the quota, while quota attainment at or over 100% indicates that the representative has met the quota. Representatives are generally rewarded for meeting or exceeding their quotas, while representatives not meeting their quotas can be cause for concern.

In some cases, the quota attainment value may be a sum, average, or weighted average of the representative's per-year quota attainment. Alternatively, time periods other than a year may be used.

But comparing actual sales to their respective quotas does not always accurately reflect representative performance. In many cases, quotas are either estimated or aspirational, and actual quota attainment within an enterprise can vary. Continuing with the example above, if mean quota attainment across all comparable representatives is 86%, then the representative with a quota attainment of 90% has probably outperformed most of his or her peers.

In order to take this into account, a normalized quota attainment may be determined. Particularly, a z-score may be calculated for the representative's quota attainment. This involves determining the aforementioned mean quota attainment (μ), as well as the standard deviation of quota attainment (σ). It is assumed that the population data for quota attainment at least roughly follows a Normal (Gaussian) distribution, but this need not be the case. In any case, the z-score for a particular representative's quota attainment (xₐ) specifies the number of standard deviations that xₐ is below or above the mean, and is given by:

$${z}_{a} = \frac{{x}_{a} - μ}{σ}$$

In practice, most values of zₐ fall into the range of −4 to 4, with approximately 68% within the range of −1 to 1. A negative zₐ indicates that the representative underperformed in terms of quota attainment when compared to his or her peers, while a positive z_{q} indicates that the representative overperformed in terms of quota attainment when compared to his or her peers. An optional weight (wₐ) may be applied to the result to scale (i.e., amplify) its values. Thus, in full generality, normalized quota attainment is given by mₐ=wₐzₐ.

This factor can further be illustrated by way of example. Suppose that μ=0.86, σ=0.54, and wₐ=20. For a first representative with a quota attainment of 90% (xₐ=0.9), mₐ=1.48. For a second representative with a quota attainment of 50% (xₐ=0.5), mₐ=−13.33. For a third representative with a quota attainment of 141% (xₐ=1.41), mₐ=20.37. These values accurately reflect that the first representative is slightly above the mean quota attainment, the second representative is below the mean quota attainment, and the third representative is far above the mean quota attainment. These values of mₐ have been rounded to two decimal places for sake of convenience.

B. Years of Data

The year of data factor considers two variables: the number of years of data that is available regarding the representative's quota attainment (x_{y}), and the number of years of data that is available regarding all representatives' quota attainments (d). In all cases, x_{y}<d. For example, an enterprise may have a total of four years of data regarding all representatives' quota attainments, but only two years of this data for a particular representative. This could be due to the representative only being with the enterprise for two years, or the representative only being in his or her current role for two years. The value for this factor can be represented as x_{y}/d. An optional weight (w_{y}) may be applied to the result to scale (i.e., amplify) this value. Thus, in full generality, normalized years of data is given by m_{y}=w_{y}x_{y}/d.

As an example, suppose that four years of data regarding all representatives' quota attainments are available (i.e., d=4), and that w_{y}=6. For the first representative, assuming there are three years of data available, this factor would take on a value of m_{y}=4.5. For the second representative, assuming there is one year of data available, this factor would take on a value of m_{y}=1.5. For the third representative, assuming there are two years of data available, this factor would take on a value of m_{y}=3. These values take into account that evaluations of representative performance should consider how long the representative has been in his or her role. The performance of more experienced representatives should be weighted more heavily that the performance of less experienced representatives.

Although years are used as the time period for this factor, time periods other than a year may be used. Thus, instead of years of data, months of data, or multi-year periods of data may be considered.

C. Tenure

A representative's tenure indicates the amount of time (e.g., the number of years) that the representative has been with the enterprise. Of interest to this calculation is the representative's tenure (xₜ) minus the years for which data is available for the representative. This can be represented as xₜ-x_{y}, which always takes on a non-negative value.

Incorporating these years without data into the evaluation can be used to recognize that representatives with a longer tenure with the enterprise are generally more knowledgeable about the enterprise, its products, and its services. Also, the longer the tenure, the higher the expectation that the representative attains his or her quota.

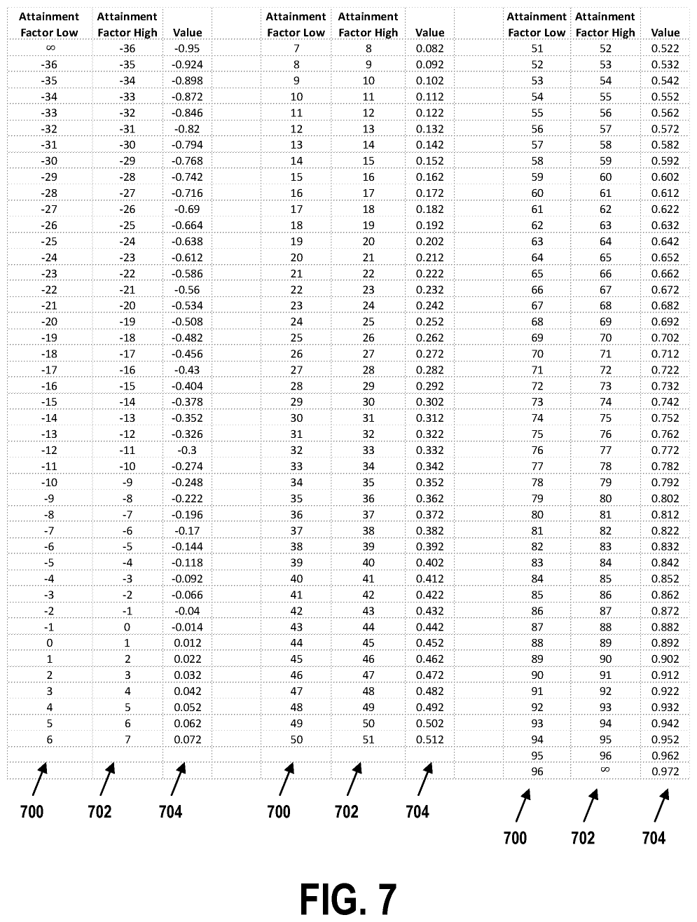

Further, xₜ-x_{y} may be scaled by ƒ(mₐ), function of mₐ, as well as an optional weight wₜ. The function may be an equation or a mapping of values of mₐ into a pre-defined range. As an example of such a function, FIG. 7 is a table that maps bands of values of mₐ into a range of −0.95 to 0.972. In this table, instances of the quota attainment factor that are within the bounds of a low attainment factor 700 and a high attainment factor 702 are mapped to a corresponding value 704. If a quota attainment factor is exactly on one of these bounds it may be mapped to either the lower or higher band. Quota attainments below −36 are assigned a value of −0.95 and quota attainments above 96 are assigned a value of 0.972. Thus, the normalized value for tenure can represented as mₜ=wₜ (xₜ-x_{y})ƒ(mₐ).

Suppose that the mappings of FIG. 7 and a value of wₜ=25 are used. Then, for the first representative with a quota attainment of 1.48, 3 years of tenure, and 2 years of data, this factor is mₜ=(3−2)(0.022)(25)=1.1. For the second representative with a quota attainment of −13.33, 2 years of tenure, and 1 year of data, this factor is mₜ=(2−1)(−0.352)(25)=−1.76. For a third representative with a quota attainment of 20.73, 5 years of tenure, and 2 years of data, this factor is mₜ=(5−2)(0.212)(25)=15.9.

D. Quota Value

The values of a representative's quota (x_{q}), x_{q} may be expressed in terms of dollars per year or dollar to date. This can be normalized by applying a weight w_{q}. Thus, in full generality, the normalized quota value may be given by m_{q}=w_{q}x_{q}.

In some embodiments, w_{q} may take on a value of 1/100,000. Thus, if the first representative has a quota of $500,000, m_{q}=5. If the second representative has a quota of $1,000,000, m_{q}=10. If the third representative has a quota of $2,000,000, m_{q}=20.

E. Scoring Equation

The factors above can be combined (e.g., additively and/or multiplicatively) in a number of ways to produce a score that specifies a representative's overall performance. Ideally, this score will be based most heavily on quota attainment, but also take the other factors into account in order to differentiate between representatives with similar quota attainments. This subsection provides such a scoring equation. Nonetheless, variations of this equation or other equations altogether may serve a similar purpose.

For purposes of this discussion, the score (s) that designates a representative's performance is as follows:

s=b+mₐm_{y}+mₜ+m_{g}

Where b is a base score designed to ensure that s is positive. With the definitions above, this expression can be expanded to:

$$s = b + {w}_{a} ( \frac{{x}_{a} - μ}{σ} ) ( \frac{{w}_{y} {x}_{y}}{d} ) + {w}_{t} ( {x}_{t} - {x}_{y} ) f ( {w}_{a} ( \frac{{x}_{a} - μ}{σ} ) ) + {w}_{q} {x}_{q}$$

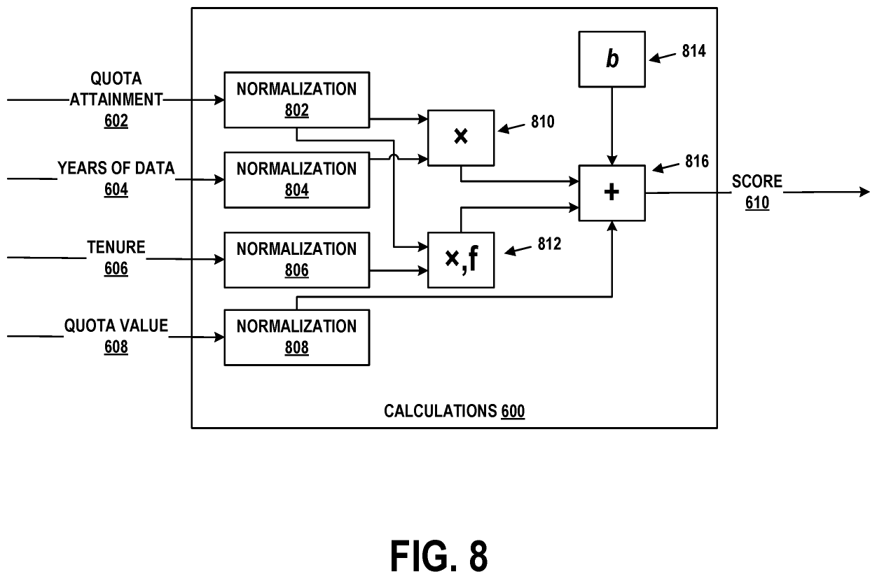

This equation is visually represented in FIG. 8. Notably, the diagram of FIG. 8 expands upon the diagram of FIG. 6 by including elements within calculations 600. In line with the discussion above of how quota attainment 602, years of data 604, tenure 606, and quota value 608 are normalized, these values are fed into normalization modules 802, 804, 806, and 808, respectively. In accordance with the definition of s, module 810 then multiplies the outputs from normalization modules 802 and 804 to produce mₐm_{y}, while module 812 applies function ƒ to the output of normalization module 802 then multiples the result to produce mₜ. As presented above, the operations of module 812 are part of normalization 806. But they are broken out in FIG. 8 for purposes of illustration. Nonetheless, these operations could be combined into normalization 806 and module 812 could be omitted.

The base score b is provided by module 814. Module 816 adds the outputs of normalization module 808 as well as modules 810, 812, and 814. The result is score 610. Nonetheless, one or more of these additive factors may be modified or omitted. For example, in some cases mₜ or m_{g} could be left out of the equation (e.g., their respective weights given a value of 0).

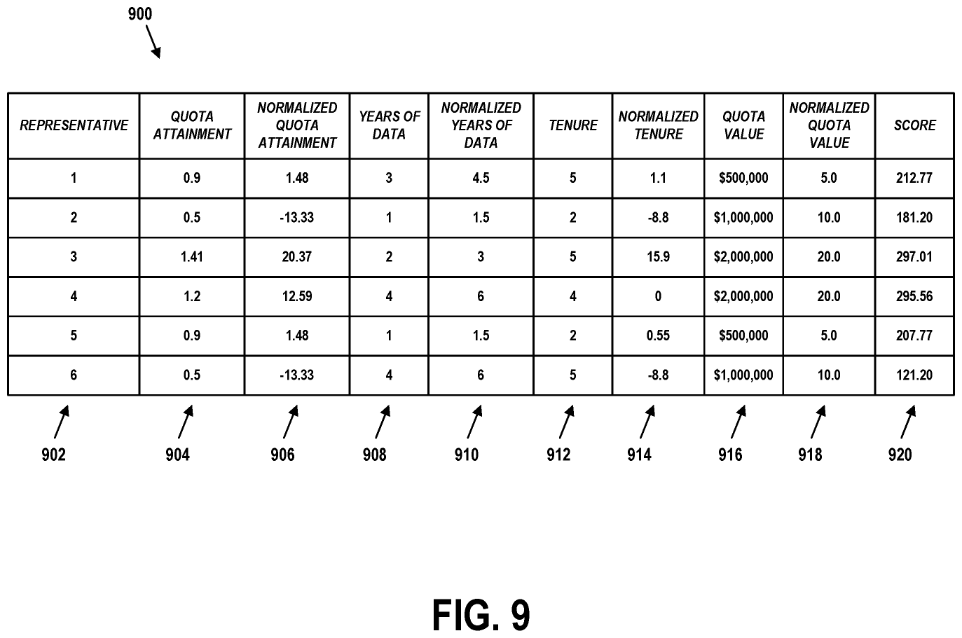

FIG. 9 illustrates the use of this equation by way of examples. In these examples, parameters are assumed to take on the values given above; that is, μ=0.86, σ=0.54, wₐ, =20, d=4, w_{y}=6, wₜ=25, w_{q}=1/100000, and the mapping for ƒ is given by FIG. 7. Further, b is given a value of 200. Notably, the values used herein for wₐ, w_{y}, wₜ, w_{q}, ƒ, and b have been determined based on experimentation to provide results that are indicative of representative performance. Nonetheless, other values for these variables may be used.

Table 900 provides examples score for six hypothetical representatives. In column 902, representative 1 is the first representative discussed above, representative 2 is the second representative discussed above, and representative 3 is the third representative discussed above. Representatives 4, 5, and 6 have not been discussed above. Column 904 shows quota attainment (xₐ), and column 906 shows normalized quota attainment (mₐ). Column 908 shows years of data (x_{y}), and column 910 shows normalized years of data (m_{y}). Column 912 shows tenure (xₜ), and column 914 shows normalized tenure (mₑ). Column 916 shows quota value (x_{q}), and column 918 shows normalized quota value (m_{q}).

Column 920 provides scores (s) that result from applying the scoring equation above to each representative's data. Of note is that the goals of the scoring equation are met in these examples—quota attainment has a primary influence on score while other parameters have a relatively smaller impact. For example, representatives 3 and 4 have the highest quota attainments and also the highest scores. The scores of representatives 3 and 4 are almost the same even though representative 3 has a somewhat higher quota attainment because there are more years of data for representative 4. Conversely, representatives 2 and 6 have the lowest quota attainments and also the lowest scores. Representative 6 has a significantly lower score than representative 2 because there are four years of data for representative 6 and only one year of data for representative 2.

### VI. Example Operations

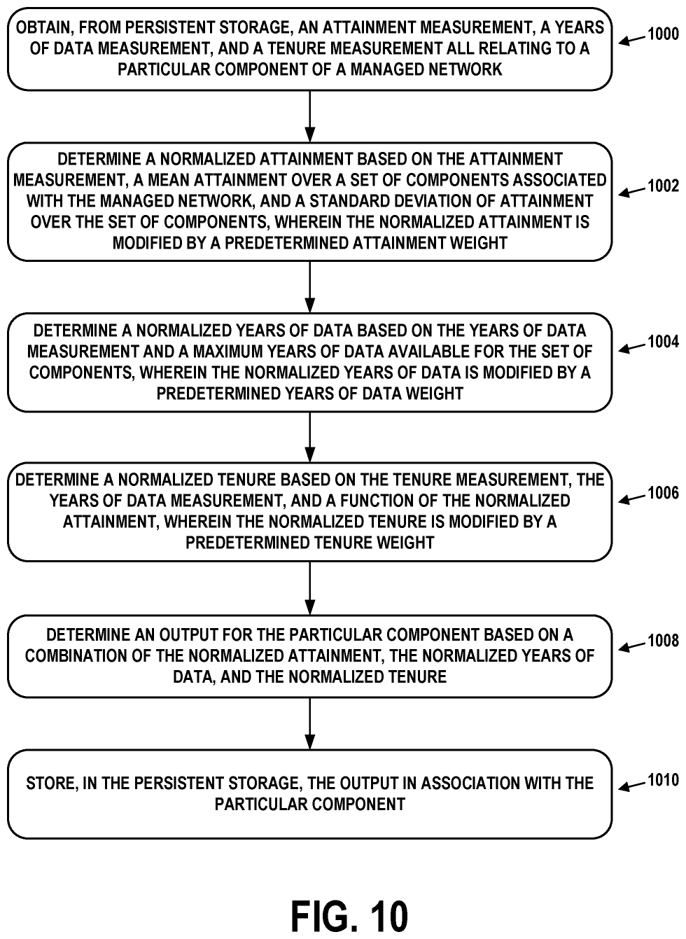

FIG. 10 is a flow chart illustrating an example embodiment. The process illustrated by FIG. 10 may be carried out by a computing device, such as computing device 100, and/or a cluster of computing devices, such as server cluster 200. However, the process can be carried out by other types of devices or device subsystems. For example, the process could be carried out by a computational instance of a remote network management platform or a portable computer, such as a laptop or a tablet device.

The embodiments of FIG. 10 may be simplified by the removal of any one or more of the features shown therein. Further, these embodiments may be combined with features, aspects, and/or implementations of any of the previous figures or otherwise described herein.

Block 1000 may involve obtaining, from persistent storage, an attainment measurement, a years of data measurement, and a tenure measurement all relating to a particular component of a managed network.

Block 1002 may involve determining a normalized attainment based on the attainment measurement, a mean attainment over a set of components associated with the managed network, and a standard deviation of attainment over the set of components, wherein the normalized attainment is modified by a predetermined attainment weight.

Block 1004 may involve determining a normalized years of data based on the years of data measurement and a maximum years of data available for the set of components, wherein the normalized years of data is modified by a predetermined years of data weight.

Block 1006 may involve determining a normalized tenure based on the tenure measurement, the years of data measurement, and a function of the normalized attainment, wherein the normalized tenure is modified by a predetermined tenure weight.

Block 1008 may involve determining an output for the particular component based on a combination of the normalized attainment, the normalized years of data, and the normalized tenure.

Block 1010 may involve storing, in the persistent storage, the output in association with the particular component.

Some embodiments may further involve obtaining a value measurement relating to the particular component, and determining a normalized value based on the value measurement, wherein the normalized value is modified by a predetermined value weight, and wherein determining the output for the particular component is also based on the normalized value.

In some embodiments, determining the normalized attainment comprises: (i) determining a z-score for the attainment measurement based on the mean attainment and standard deviation of attainment; and (ii) multiplying the z-score by the predetermined attainment weight.

In some embodiments, determining the normalized years of data comprises: (i) obtaining a quotient by dividing the years of data measurement by the maximum years of data available; and (ii) multiplying the quotient by the predetermined years of data weight.

In some embodiments, determining the normalized tenure comprises: (i) obtaining a difference by subtracting the years of data measurement from the tenure measurement; (ii) obtaining a product by multiplying the difference by the function of the normalized attainment; and (iii) multiplying the product by the predetermined tenure weight.

In some embodiments, the function of the normalized attainment maps the normalized attainment into a range from approximately −1 and approximately 1. The range may deviate from these boundaries of −1 and 1 by 10-20%. The function of the normalized attainment may use a table associating bands of the normalized attainment to output values within the range.

In some embodiments, the components of the managed network are computing devices disposed within the managed network.

In some embodiments, the components of the managed network are units of industrial or scientific equipment associated with the managed network.

In some embodiments, the components of the managed network are employees of the managed network. The employees of the managed network may be sales representatives.

In some embodiments, determining output for the particular component based on the combination of the normalized attainment, the normalized years of data, and the normalized tenure comprises multiplying the normalized attainment by the normalized years of data and then adding the normalized tenure. Other linear or non-linear combinations may be possible.

In some embodiments, the output is a performance evaluation of the particular component.

Some embodiments may further involve: (i) generating, for display on a client device, a representation of a graphical user interface that contains inputs for the attainment measurement, the years of data measurement, and the tenure measurement; (ii) receiving, from the client device and by way of the inputs, the attainment measurement, the years of data measurement, and the tenure measurement; and (iii) storing, in the persistent storage, the attainment measurement, the years of data measurement, and the tenure measurement.

Some embodiments may further involve: generating, for display on a client device, a representation of a graphical user interface that contains the output visually associated with one or more of the attainment measurement, the years of data measurement, the tenure measurement, the normalized attainment, the normalized years of data, or the normalized tenure.

### VII. Closing

The present disclosure is not to be limited in terms of the particular embodiments described in this application, which are intended as illustrations of various aspects. Many modifications and variations can be made without departing from its scope, as will be apparent to those skilled in the art. Functionally equivalent methods and apparatuses within the scope of the disclosure, in addition to those described herein, will be apparent to those skilled in the art from the foregoing descriptions. Such modifications and variations are intended to fall within the scope of the appended claims.

The above detailed description describes various features and operations of the disclosed systems, devices, and methods with reference to the accompanying figures. The example embodiments described herein and in the figures are not meant to be limiting. Other embodiments can be utilized, and other changes can be made, without departing from the scope of the subject matter presented herein. It will be readily understood that the aspects of the present disclosure, as generally described herein, and illustrated in the figures, can be arranged, substituted, combined, separated, and designed in a wide variety of different configurations.

With respect to any or all of the message flow diagrams, scenarios, and flow charts in the figures and as discussed herein, each step, block, and/or communication can represent a processing of information and/or a transmission of information in accordance with example embodiments. Alternative embodiments are included within the scope of these example embodiments. In these alternative embodiments, for example, operations described as steps, blocks, transmissions, communications, requests, responses, and/or messages can be executed out of order from that shown or discussed, including substantially concurrently or in reverse order, depending on the functionality involved. Further, more or fewer blocks and/or operations can be used with any of the message flow diagrams, scenarios, and flow charts discussed herein, and these message flow diagrams, scenarios, and flow charts can be combined with one another, in part or in whole.

A step or block that represents a processing of information can correspond to circuitry that can be configured to perform the specific logical functions of a herein-described method or technique. Alternatively or additionally, a step or block that represents a processing of information can correspond to a module, a segment, or a portion of program code (including related data). The program code can include one or more instructions executable by a processor for implementing specific logical operations or actions in the method or technique. The program code and/or related data can be stored on any type of computer readable medium such as a storage device including RAM, a disk drive, a solid state drive, or another storage medium.

The computer readable medium can also include non-transitory computer readable media such as computer readable media that store data for short periods of time like register memory and processor cache. The computer readable media can further include non-transitory computer readable media that store program code and/or data for longer periods of time. Thus, the computer readable media may include secondary or persistent long term storage, like ROM, optical or magnetic disks, solid state drives, or compact-disc read only memory (CD-ROM), for example. The computer readable media can also be any other volatile or non-volatile storage systems. A computer readable medium can be considered a computer readable storage medium, for example, or a tangible storage device.

Moreover, a step or block that represents one or more information transmissions can correspond to information transmissions between software and/or hardware modules in the same physical device. However, other information transmissions can be between software modules and/or hardware modules in different physical devices.

The particular arrangements shown in the figures should not be viewed as limiting. It should be understood that other embodiments can include more or less of each element shown in a given figure. Further, some of the illustrated elements can be combined or omitted. Yet further, an example embodiment can include elements that are not illustrated in the figures.

While various aspects and embodiments have been disclosed herein, other aspects and embodiments will be apparent to those skilled in the art. The various aspects and embodiments disclosed herein are for purpose of illustration and are not intended to be limiting, with the true scope being indicated by the following claims.

What is claimed is:

1. A system comprising:
persistent storage within a computational instance of a remote network management platform, wherein the computational instance is dedicated to a managed network, and wherein the persistent storage includes measurements relating to components of the managed network; and
one or more processors configured to:
obtain, from the persistent storage, an attainment measurement, a years of data measurement, and a tenure measurement all relating to a particular component of the managed network;
determine a normalized attainment based on the attainment measurement, a mean attainment over a set of the components, and a standard deviation of attainment over the set of the components, wherein the normalized attainment is modified by a predetermined attainment weight;
determine a normalized years of data based on the years of data measurement and a maximum years of data available for the set of the components, wherein the normalized years of data is modified by a predetermined years of data weight;
determine a normalized tenure based on the tenure measurement, the years of data measurement, and a function of the normalized attainment, wherein the normalized tenure is modified by a predetermined tenure weight;
determine an output for the particular component based on a combination of the normalized attainment, the normalized years of data, and the normalized tenure; and
store, in the persistent storage, the output in association with the particular component.

2. The system of claim 1, wherein the one or more processors are further configured to:
obtain a value measurement relating to the particular component; and
determine a normalized value based on the value measurement, wherein the normalized value is modified by a predetermined value weight, and wherein determining the output for the particular component is also based on the normalized value.

3. The system of claim 1, wherein determining the normalized attainment comprises:
determining a z-score for the attainment measurement based on the mean attainment and standard deviation of attainment; and
multiplying the z-score by the predetermined attainment weight.

4. The system of claim 1, wherein determining the normalized years of data comprises:
obtaining a quotient by dividing the years of data measurement by the maximum years of data available; and
multiplying the quotient by the predetermined years of data weight.

5. The system of claim 1, wherein determining the normalized tenure comprises:
obtaining a difference by subtracting the years of data measurement from the tenure measurement;
obtaining a product by multiplying the difference by the function of the normalized attainment; and
multiplying the product by the predetermined tenure weight.

6. The system of claim 1, wherein the function of the normalized attainment maps the normalized attainment into a range from approximately −1 and approximately 1.

7. The system of claim 6, wherein the function of the normalized attainment uses a table associating bands of the normalized attainment to output values within the range.

8. The system of claim 1, wherein the components of the managed network are computing devices disposed within the managed network.

9. The system of claim 1, wherein the components of the managed network are units of industrial or scientific equipment associated with the managed network.

10. The system of claim 1, wherein the components of the managed network are employees of the managed network.

11. The system of claim 10, wherein the employees of the managed network are sales representatives.

12. The system of claim 1, wherein determining output for the particular component based on the combination of the normalized attainment, the normalized years of data, and the normalized tenure comprises multiplying the normalized attainment by the normalized years of data and then adding the normalized tenure.

13. The system of claim 1, wherein the output is a performance evaluation of the particular component.

14. The system of claim 1, wherein the one or more processors are further configured to:
generate, for display on a client device, a representation of a graphical user interface that contains inputs for the attainment measurement, the years of data measurement, and the tenure measurement;
receive, from the client device and by way of the inputs, the attainment measurement, the years of data measurement, and the tenure measurement; and
store, in the persistent storage, the attainment measurement, the years of data measurement, and the tenure measurement.

15. The system of claim 1, wherein the one or more processors are further configured to:
generate, for display on a client device, a representation of a graphical user interface that contains the output visually associated with one or more of the attainment measurement, the years of data measurement, the tenure measurement, the normalized attainment, the normalized years of data, or the normalized tenure.

16. A computer-implemented method comprising:
obtaining, from persistent storage, an attainment measurement, a years of data measurement, and a tenure measurement all relating to a particular component of a managed network;
determining a normalized attainment based on the attainment measurement, a mean attainment over a set of components associated with the managed network, and a standard deviation of attainment over the set of components, wherein the normalized attainment is modified by a predetermined attainment weight;
determining a normalized years of data based on the years of data measurement and a maximum years of data available for the set of components, wherein the normalized years of data is modified by a predetermined years of data weight;
determining a normalized tenure based on the tenure measurement, the years of data measurement, and a function of the normalized attainment, wherein the normalized tenure is modified by a predetermined tenure weight;
determining an output for the particular component based on a combination of the normalized attainment, the normalized years of data, and the normalized tenure; and
storing, in the persistent storage, the output in association with the particular component.

17. The computer-implemented method of claim 16, determining the normalized attainment comprises:
determining a z-score for the attainment measurement based on the mean attainment and standard deviation of attainment; and
multiplying the z-score by the predetermined attainment weight.

18. The computer-implemented method of claim 16, wherein determining the normalized years of data comprises:
obtaining a quotient by dividing the years of data measurement by the maximum years of data available; and
multiplying the quotient by the predetermined years of data weight.

19. The computer-implemented method of claim 16, wherein determining the normalized tenure comprises:
obtaining a difference by subtracting the years of data measurement from the tenure measurement;
obtaining a product by multiplying the difference by the function of the normalized attainment; and
multiplying the product by the predetermined tenure weight.

20. An article of manufacture including a non-transitory computer-readable medium, having stored thereon program instructions that, upon execution by a computing system, cause the computing system to perform operations comprising:
obtaining, from persistent storage, an attainment measurement, a years of data measurement, and a tenure measurement all relating to a particular component of a managed network;
determining a normalized attainment based on the attainment measurement, a mean attainment over a set of components associated with the managed network, and a standard deviation of attainment over the set of components, wherein the normalized attainment is modified by a predetermined attainment weight;
determining a normalized years of data based on the years of data measurement and a maximum years of data available for the set of components, wherein the normalized years of data is modified by a predetermined years of data weight;
determining a normalized tenure based on the tenure measurement, the years of data measurement, and a function of the normalized attainment, wherein the normalized tenure is modified by a predetermined tenure weight;
determining an output for the particular component based on a combination of the normalized attainment, the normalized years of data, and the normalized tenure; and
storing, in the persistent storage, the output in association with the particular component.
